(19) United States
(12) Patent Application Publication
(10) Pub. No.: US 2013/0224597 A1
(43) Pub. Date: Aug. 29, 2013

(54) NONAQUEOUS ELECTROLYTE SECONDARY BATTERY HAVING A LITHIUM-CONTAINING TRANSITION METAL OXIDE COATED WITH A FILM CONTAINING Li, B and C AS A POSITIVE ACTIVE MATERIAL

(71) Applicant: SANYO ELECTRIC CO., LTD., (US)

(72) Inventors: Takanobu CHIGA, Osaka (JP); Katsunori YANAGIDA, Osaka (JP)

(73) Assignee: SANYO ELECTRIC CO., LTD., Osaka (JP)

(21) Appl. No.: 13/665,797

(22) Filed: Oct. 31, 2012

Related U.S. Application Data
(63) Continuation of application No. 12/318,916, filed on Jan. 12, 2009.

(30) Foreign Application Priority Data
Jan. 10, 2008 (JP) 3223/2008

(51) Int. Cl. H01M 4/48; H01M 4/136

(52) U.S. Cl. 429/231.6; 429/231.7; 429/231.8; 429/231.95

(57) ABSTRACT

A nonaqueous electrolyte secondary battery is obtained which shows good cycle characteristics even when charged to a high voltage. The nonaqueous electrolyte secondary battery has a positive electrode containing a positive active material, a negative electrode containing a negative active material and a nonaqueous electrolyte, wherein a lithium-containing transition metal oxide having a layered structure is contained in the positive electrode as the positive active material, an additive which is reductively decomposed in the range of +3.0-1.3 V versus metallic lithium is contained in the nonaqueous electrolyte, and the battery after assembled is overdischarged until a potential of the positive electrode falls down to a reductive potential of the additive or below.

This application is a division of application Ser. No. 12/318,916, filed Jan. 12, 2009, which claims priority based on Japanese Patent Application No. 2008-3223, filed Jan. 10, 2008, and which is incorporated herein by reference.

### BACKGROUND OF THE INVENTION

1. Field of the Invention

The present invention relates to a nonaqueous electrolyte secondary battery, such as a lithium-ion secondary battery, and a manufacturing method thereof.

2. Description of Related Art

Recent years have seen the rapid progress of reduction in size and weight of mobile information terminals such as mobile telephones, notebook personal computers and PDA, and further capacity increase has been demanded for secondary batteries used as a driving power source. As a secondary battery which can meet such demand, a nonaqueous electrolyte secondary battery capable of increasing a battery voltage has been noticed. In particular, a lithium-ion secondary battery has been generally employed which uses a lithium-containing transition metal oxide as a positive active material and a graphite-based carbon material as a negative active material. However, it is hard to say that current lithium-ion secondary batteries have fully met the demands of recent mobile information terminals. Further improvement in capacity and durability thereof is expected.

An effective measure to achieve a capacity improvement is to increase a charge voltage of a battery. This is because the higher charge voltage increases the amount of lithium ions extracted from the positive active material and accordingly improves a utilization factor of the positive active material. For example, when lithium cobaltate, which is a generally-used positive active material, is charged to 4.3 V versus metallic lithium, its capacity is about 160 mAh/g. When it is charged to 4.5 V and 4.6 V versus metallic lithium, its capacity can be improved to about 190 mAh/g and 220 mAh/g, respectively.

However, charging lithium cobaltate or other positive active material to a higher voltage accelerates decomposition of an electrolyte solution, that results in the difficulty to obtain satisfactory cycle characteristics. For example, Japanese Patent Laid-open No. 2005-50779 describes that addition of a different element to lithium cobaltate assures satisfactory cycle characteristics even if charged to 4.5 V versus metallic lithium (a battery voltage of 4.4 V in case where a graphite-based carbon material is used as a negative active material). However, no discussion is provided as to the improvement of cycle characteristics when lithium cobaltate is charged to a higher voltage, e.g., to 4.6 V versus metallic lithium.

Although desired to increase a charge voltage from a view to increasing an energy density of a battery, such a voltage increase, if applied to conventional secondary batteries, accelerates decomposition of an electrolyte solution on a positive electrode and results in the difficulty to obtain satisfactory cycle characteristics. Under such circumstances, it is expected to develop a nonaqueous electrolyte secondary battery which shows good cycle characteristics even when a charge voltage is increased.

In the present invention, a battery is overdischarged using a nonaqueous electrolyte incorporating a specific additive, as will be described below. On the other hand, in Japanese Patent Laid-open Nos. Hei 11-204148 and Hei 11-297362, overdischarging is performed for the purposes different from that of the present invention. Specifically, in Japanese Patent Laid-open No. Hei 11-204148, overdischarging is carried out to effect release of lithium contained in a carbon negative electrode, whereby a charge/discharge efficiency is improved. In Japanese Patent Laid-open No. Hei 11-297362, overdischarging is performed to remove a passivated film on an alkaline metal negative electrode. Also in Japanese Patent Laid-open Nos. Hei 11-204148 and Hei 11-297362, lithium manganate having a spinel structure is contained as a positive active material. In this respect, they are distinguished from the present invention which uses a positive active material having a layered structure.

### SUMMARY OF THE INVENTION

It is an object of the present invention to provide a nonaqueous electrolyte secondary battery which exhibits good cycle characteristics even when charged to a high voltage and a manufacturing method thereof.

The nonaqueous electrolyte secondary battery of the present invention has a positive electrode containing a positive active material, a negative electrode containing a negative active material and a nonaqueous electrolyte. Characteristically, a lithium-containing transition metal oxide having a layered structure is contained as the positive active material. An additive which is reductively decomposed in the range of +3.0-1.3 V versus metallic lithium is contained in the nonaqueous electrolyte. Also, the battery after assembled is overdischarged until a potential of the positive electrode falls down to a reductive potential of the additive or below.

In the present invention, the additive which is reductively decomposed in the range of +3.0-1.3 V versus metallic lithium is contained in the nonaqueous electrolyte. Also, the battery after assembled is overdischarged until a potential of the positive electrode falls down to a reductive potential of the additive or below. These subject the additive to reductive decomposition on a surface of the positive electrode, so that a film produced via reductive decomposition of the additive is deposited on the positive electrode surface. Due to the formation of such a film on the positive electrode surface, good cycle characteristics can be obtained even when the battery is charged to a high voltage. Such an effect of the present invention is below described more specifically.

It is generally known in the art of lithium-ion secondary batteries that formation of an electronically non-conductive but lithium-ion permeable film is effective in suppressing decomposition of an electrolyte solution on an electrode. This film is called SEI (solid electrolyte interface). Particularly for secondary batteries which use a material having a low potential such as graphite for a negative electrode, it becomes essential to form a good SEI on a surface of the negative electrode. Such a film is formed as a result of deposition of a decomposition product onto the negative electrode surface when the electrolyte solution experiences reductive decomposition and is composed such as of LiF and lithium alkylcarbonate. It is believed that, in the formation of the SEI, the electrolyte solution receives electrons from the negative electrode to undergo reductive decomposition and then combines with lithium to produce lithium-containing compounds. The movement of lithium in these compounds is believed to impart lithium-ion permeability. As described hereinabove, it is believed that the electrolyte solution receives electrons from the electrode through reductive decomposition and then combines with lithium ions having a plus charge to form lithium-containing compounds on the surface.

The present invention is contemplated to form such SEI on a surface of a positive electrode.

In the present invention, the additive which is reductively decomposed in the range of +3.0-1.3 V versus metallic lithium is added to the nonaqueous electrolyte. Also, the battery after assembled is overdischarged so that a potential of the positive electrode falls down to a reductive potential of the additive or below. Accordingly, a film produced via reductive decomposition of the additive is deposited on the positive electrode surface.

Unless the battery after assembled is overdischarged in the manner as described above, the additive contained in the nonaqueous electrolyte is reductively decomposed on a surface of the negative electrode to form a film on the negative electrode surface. In this case, such reductive decomposition does not result in the formation of a film on the positive electrode surface.

In an exemplary case where lithium cobaltate is used in a positive active material, graphite is used for a negative active material and LiB(C₂O₄)₂ is used as an additive, a potential of a negative electrode at the time when an electrolyte solution is poured is about +3.0 V versus metallic lithium. The potential of the negative electrode decreases with charging. When it reaches about +2.0 V, which is a reductive potential of LiB(C₂O₄)₂, LiB(C₂O₄)₂ is reductively decomposed to form a film on a surface of the negative electrode. A potential of a positive electrode at the time when the electrolyte solution is poured is about +3.0 V versus metallic lithium and increases therefrom with charging. Accordingly, LiB(C₂O₄)₂ is not reductively decomposed on a surface of the positive electrode and the film is formed solely on the surface of negative electrode. Hence, reductive decomposition has not resulted in successful formation of the film on the surface of positive electrode for conventional secondary batteries.

In the present invention, the battery after assembled is overdischarged until the potential of the positive electrode falls down to a reductive potential of the additive or below, whereby the additive is reductively decomposed on the positive electrode surface and, as a result of reductive decomposition, the film is formed on the positive electrode surface. Due to the formation of the film on the positive electrode surface, good cycle characteristics can be obtained even when the battery is charged to a high voltage.

In the present invention, a compound which is reductively decomposed in the range of +3.0-1.3 V versus metallic lithium is used as the additive. The use of a compound which is reductively decomposed at a potential of below +1.3 V is undesirable because this potential level allows aluminum, a generally-used positive current collector, to alloy with lithium or causes decomposition of the positive active material. Also, because a potential of the positive active material having a layered structure such as represented by lithium cobaltate is about +3.0 V at the time when the electrolyte solution is poured, the additive is used which undergoes reductive decomposition at a potential of not exceeding +3.0 V. More preferably, the potential at which the additive is reductively decomposed is in the range of +2.5-1.5 V versus metallic lithium.

Specific examples of additives useful in the present invention are lithium salts such as LiB(C₂O₄)₂ and LiBF₂(C₂O₄)

In the present invention, the amount of the additive contained in the nonaqueous electrolyte is preferably in the range of 0.01-0.5 mol/liter, more preferably in the range of 0.05-0.2 mol/liter. If the amount of the additive is excessively small, film formation on the positive electrode surface may proceed insufficiently to result in the insufficient improvement of cycle characteristics. On the other hand, if the amount of the additive is excessively large, excessive reductive decomposition may occur to cause an increase of an internal resistance or evolution of a gas.

In the present invention, the battery is overdischarged until the potential of positive electrode falls down to the reductive potential of the additive or below. The timing of overdischarging may be prior to conventional charging that is performed after assembly of the battery. Overdischarging may alternatively be performed subsequent to a normal charging procedure, that is, after the potential of the positive electrode is increased to a predetermined charge level. Alternatively, subsequent to several conventional charge-discharge cycles, overdischarging may be performed to form the film on the positive electrode surface.

In the present invention, the battery is preferably charged until the potential of the positive electrode increases to 4.30 V versus metallic lithium or above, more preferably 4.50 V versus metallic lithium or above. In accordance with the present invention, good cycle characteristics can be obtained even if the battery is charged to such a high voltage.

In this invention, the lithium-containing transition metal oxide having a layered structure is contained as the positive active material. From the standpoint of forming the film on the positive electrode surface on overdischarge, the positive active material in the present invention is preferably of the type that has no discharge capacity in a region lower than a potential at the time when the nonaqueous electrolyte is poured. From this point of view, in the present invention, the lithium-containing transition metal oxide having a layered structure is contained as the positive active material. Specific examples of preferably useful lithium-containing transition metal oxides having a layered structure include lithium cobaltate, a lithium-containing complex oxide of cobalt-nickel-manganese, and a lithium-containing complex oxide of aluminum-nickel-cobalt. In particular, the use of lithium cobaltate having Al or Mg incorporated in the form of a solid solution inside a crystal and Zr added to particle surfaces is preferred from a standpoint of stability of its crystal structure. Such lithium cobaltate can be produced according to the method disclosed in Japanese Patent Laid-open No. 2005-50779.

In the present invention, the above-specified positive active material may be used alone or in combination with other type of positive active material. The positive active material may be mixed with an electroconductor such as acetylene black or carbon black and a binder such as polytetrafluoroethylene (PTFE) or polyvinylidene fluoride (PVdF) for use as a cathode mix. Generally, the positive electrode can be fabricated by applying the cathode mix slurry onto a current collector such as an aluminum foil.

Lithium manganate (LiMn₂O₄) having a spinel structure exhibits a potential of about 3 V versus metallic lithium at the time when a nonaqueous electrolyte is poured, but is capable of further lithium insertion from a starting composition LiMn₂O₄. Accordingly, it exhibits a discharge capacity at a potential of 3 V or below. This leads to a possibility that in the case lithium manganate is used, if overdischarging is performed, a reaction of inserting lithium in the positive active material occurs to prevent a potential of the positive electrode from decreasing to the reductive potential of the additive or below. Also, the use of spinel lithium manganate in a capacity region below 3 V deteriorates cycle characteristics. Hence, the spinel lithium manganate is not preferable for use as the positive active material of the present invention.

The negative active material for use in the present invention is not particularly specified, so long as it is capable of storing and releasing lithium. Examples of useful negative active materials include metallic lithium and lithium alloys such as lithium-aluminum alloy, lithium-silicon alloy and lithium-tin alloy; carbon materials such as graphite, cokes and burned organics; and metal oxides having a low potential compared to the positive active material, such as SnO₂, SnO and TiO₂.

The negative active material may be mixed with a binder, e.g., styrene-butadiene rubber (SBR), polytetrafluoroethylene (PTFE) or polyvinylidene fluoride (PVdF), for use as an anode mix, for example. Generally, the negative electrode can be fabricated by applying the anode mix slurry onto a current collector such as a copper foil.

In the present invention, the battery is overdischarged until a potential of the positive electrode falls down to +3.0-1.3 V versus metallic lithium so that a film is formed on a surface of the positive electrode as a result of reductive decomposition of the additive. While overdischarged in the positive electrode, an oxidation reaction takes place in the negative electrode. In this case, if a lithium-free material such as graphite is used for the negative active material, its inability of extracting lithium leads to dissolution of the negative current collector such as copper and also causes reversal of a battery voltage, that is, a phenomenon where the negative electrode becomes higher in potential than the positive electrode. Thus, the use of lithium-containing negative active material such as metallic lithium or lithium-aluminum alloy is preferred. In the case where the lithium-free negative active material such as graphite or silicon is used, it may preferably be predoped with lithium. It is therefore preferable that the negative active material contains lithium on assembly of the battery.

In the present invention, a solvent useful for the nonaqueous electrolyte may be chosen from those conventionally used for nonaqueous electrolyte secondary batteries, for example. Examples of such solvents include cyclic carbonate esters such as ethylene carbonate, propylene carbonate, 1,2-butylene carbonate and 2,3-butylene carbonate; cyclic esters such as γ-butyrolactone and propanesultone; chain carbonate esters such as ethylmethyl carbonate, diethyl carbonate and dimethyl carbonate; chain ethers such as 1,2-dimethoxyethane, 1,2-diethoxyethane, diethyl ether and ethylmethyl ether; and methyl acetate, ethyl acetate, propyl acetate, methyl propionate, ethyl propionate, tetrahydrofuran, 2-methyltetrahydrofuran, 1,4-dioxane and acetonitrile.

Also, addition of vinylene carbonate, vinylethylene carbonate, ethylene sulfite, 4-fluoroethylene carbonate or any of their derivatives to the nonaqueous electrolyte results in the formation of a stable film having improved lithium-ion permeability on a surface of the negative electrode.

In the present invention, examples of lithium salts for incorporation in the nonaqueous electrolyte, other than the above-described additive of the present invention, include LiPF₆, LiBF₄, LiCF₃SO₃, LiClO₄, LiN(C₂F₅SO₂)₂, LiN(CF₃SO₂)₂, LiN(FSO₂)₂, LiC(C₂F₅SO₂)₃ and LiC(CF₃SO₂)₃. Among them, LiPF₆, LiBF₄ and LiN(CF₃SO₂)₂ are preferably used.

The concentration of the lithium salt, other than the additive, in the nonaqueous electrolyte is not particularly specified, but may generally preferably be in the range of 0.5-2.0 mol/liter.

Also in the present invention, while the additive contained in the nonaqueous electrolyte is a substance that is reductively decomposed by the overdischarging to form the film on the positive electrode surface, as described above, it is also capable of forming the film on a surface of the negative electrode as conventional.

The nonaqueous electrolyte secondary battery in accordance with another aspect of the present invention has a positive electrode containing a positive active material, a negative electrode containing a negative active material and a nonaqueous electrolyte. Characteristically, a lithium-containing transition metal oxide having a layered structure is contained as the positive active material, an additive which is reductively decomposed in the range of +3.0-1.3 V versus metallic lithium is contained in the nonaqueous electrolyte, and a film produced via reductive decomposition of the additive is deposited on a surface of the positive electrode.

Since the film produced via reductive decomposition of the additive is deposited on the surface of its positive electrode, the nonaqueous electrolyte secondary battery in accordance with another aspect of the present invention can obtain good cycle characteristics even when it is charged to a high voltage, as described above.

The manufacturing method of the present invention is the one by which the nonaqueous electrolyte secondary battery of the present invention can be manufactured and is characterized as including the steps of adding an additive to a nonaqueous electrolyte, and subsequent to assembly of a battery using a positive electrode, a negative electrode and a nonaqueous electrolyte, overdischarging the battery until a potential of the positive electrode falls down to a reductive potential of the additive or below.

In accordance with the manufacturing method of the present invention, the battery after assembled is overdischarged until a potential of the positive electrode falls down to a reductive potential of the additive or below. This enables deposition of the film produced via reductive decomposition of the additive on a surface of the positive electrode, so that the nonaqueous electrolyte secondary battery is made to exhibit good cycle characteristics even when it is charged to a high voltage.

In accordance with the present invention, the film produced via reductive decomposition of the additive can be deposited on the positive electrode surface. Accordingly, good cycle characteristics can be obtained even when the battery is charged to a high voltage.

In accordance with the manufacturing method of the present invention, the film can be produced via reductive decomposition of the additive and deposited on the surface of positive electrode, so that a nonaqueous electrolyte secondary battery can be manufactured which shows good cycle characteristics even when charged to a high voltage.

### BRIEF DESCRIPTION OF THE DRAWINGS

FIG. 1 is a graph which shows CV measurement results when the nonaqueous electrolyte A containing LiB(C₂O₄)₂ is used;

FIG. 2 is a graph which shows CV measurement results when the nonaqueous electrolyte B containing LiBF₂(C₂O₄) is used; and

FIG. 3 is a graph which shows CV measurement results when the nonaqueous electrolyte C excluding the additive.

### DESCRIPTION OF THE PREFERRED EXAMPLES

The present invention is described below in more detail by way of Examples. It will be recognized that the following examples merely illustrate the present invention and are not intended to be limiting thereof. Suitable changes can be effected without departing from the scope of the present invention.

(Fabrication of Positive Electrode)

Lithium cobaltate having 0.5 mole % of Mg in the form of a solid solution and 0.2 mole % of Zr added to its surface was prepared for use as a positive active material. This positive active material, a carbon material as an electrical conductor and PVdF as a binder, in the ratio by weight of 95:2.5:2.5, were added to N-methyl-2-pyrrolidone (NMP) as a solvent. The resulting mixture was kneaded to prepare a cathode slurry. The prepared slurry was coated onto opposite sides of an aluminum foil as a current collector, dried and then calendered to provide a positive electrode.

(Preparation of Nonaqueous Electrolyte A)

Ethylene carbonate (EC) and ethylmethyl carbonate (EMC) in the ratio by volume of 30:70 were mixed. LiPF₆ and then LiB(C₂O₄)₂ as the additive were added to this mixed solvent in respective concentrations of 1.0 mol/liter and 0.1 mol/liter to prepare a nonaqueous electrolyte A.

(Preparation of Nonaqueous Electrolyte B)

Ethylene carbonate (EC) and ethylmethyl carbonate (EMC) in the ratio by volume of 30:70 were mixed. LiPF₆ and then LiBF₂(C₂O₄) as the additive were added to this mixed solvent in respective concentrations of 1.0 mol/liter and 0.1 mol/liter to prepare a nonaqueous electrolyte B

(Preparation of Nonaqueous Electrolyte C)

Ethylene carbonate (EC) and ethylmethyl carbonate (EMC) in the ratio by volume of 30:70 were mixed. LiPF₆ was added to this mixed solvent in a concentration of 1.0 mol/liter to prepare a nonaqueous electrolyte C.

(Construction of Three-Electrode Test Cell)

A beaker-type cell was used with each of the above-prepared nonaqueous electrolytes A, B and C to construct three-electrode test cells. A work electrode was cut out from the above positive electrode. A counter electrode and a reference electrode were each cut out from a rolled lithium plate.

(CV Measurement)

The above three-electrode test cells using the nonaqueous electrolytes A, B and C were subjected to a CV measurement. Each cell was swept from an open circuit voltage (OCV) to 1.0 V in the reduction side and then to 5.0 V in the oxidation side with a scan rate of 1 mV/sec. Testing was carried out at room temperature.

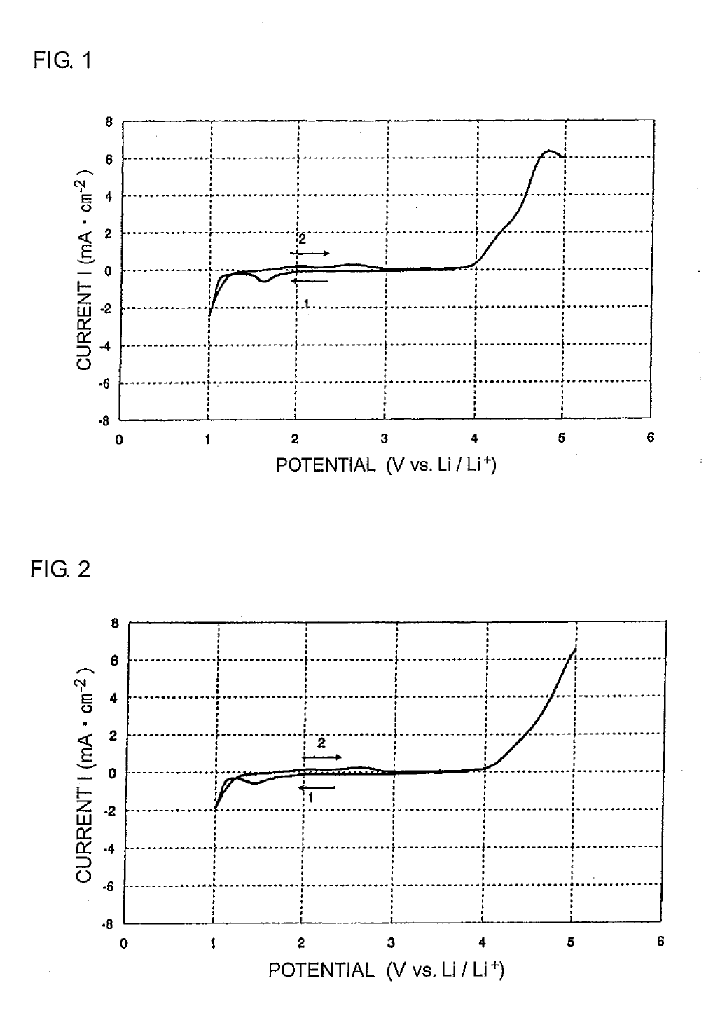

The measurement results for the test cells using the nonaqueous electrolytes A, B and C are shown in FIGS. 1, 2 and 3, respectively.

As can be clearly seen from the results shown in FIG. 1, in the case of the nonaqueous electrolyte A using LiB(C₂O₄)₂ for the additive, a reductive current is observed in a region below approximately 2.0 V. As can be seen from the results shown in FIG. 2, in the case of the nonaqueous electrolyte B using LiBF₂(C₂O₄) for the additive, a reductive current is observed in a region below approximately 1.7 V. Accordingly, in cases of using either additive, formation of a film on the positive electrode surface has been confirmed.

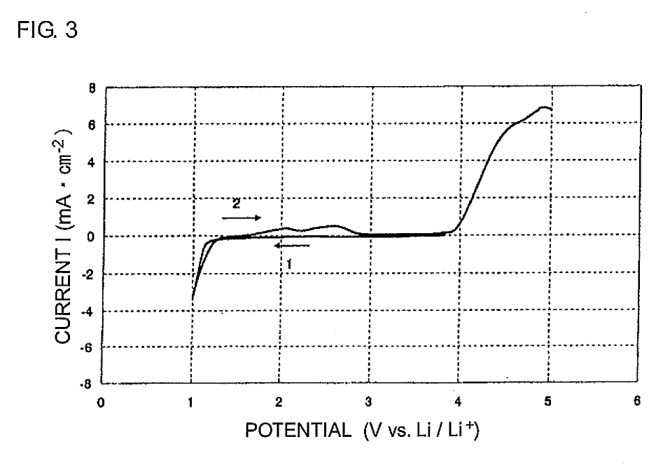

In contrast, no reductive current was observed for the nonaqueous electrolyte C excluding the additive, as shown in FIG. 3.

Also in cases of using either electrolyte, a reductive current is observed in a region below approximately 1.3 V. This is believed to show that aluminum used as the current collector has alloyed with lithium. From this, it has been found that the additive for use in the present invention needs to be reductively decomposed at 1.3 V or above.

### Example 1

(Construction of Battery)

The above-fabricated positive electrode and metallic lithium (0.3 mm thick) as a negative electrode were rolled up with a polyethylene separator between them to fabricate a rolled-up structure. Thereafter, this rolled-up structure and the nonaqueous electrolyte A were placed in a glove box under inert gas atmosphere where they were introduced in an outer casing made of a laminate film which was subsequently sealed to complete construction of a nonaqueous electrolyte secondary battery.

The constructed battery showed a battery voltage of about 3.2 V. Subsequently, the battery was overdischarged by sustaining its voltage at 1.6 V for 10 minutes to form a film via reductive decomposition of the additive on a surface of the positive electrode. This battery was designated as the battery of the present invention.

### Comparative Example 1

The procedure of Example 1 was followed, with the exception that the additive-free nonaqueous electrolyte C was used and overdischarging was not performed, to construct a comparative battery 1.

### Comparative Example 2

The procedure of Example 1 was followed, with the exception that the nonaqueous electrolyte A was used and overdischarging for film formation was not performed, to construct a comparative battery 2.

### Comparative Example 3

The procedure of Example 1 was followed, with the exception that the additive-free nonaqueous electrolyte C was used, to construct a comparative battery 3.

(Measurement of Initial Discharge Capacity)

The above-constructed battery of the present invention and comparative batteries 1-3 were measured for initial discharge capacity according to the following procedure.

Each battery was charged at 0.75 mA/cm² to 4.6 V, again charged at 0.25 mA/cm² to 4.6 V and then discharged at 0.75 mA/cm² to 2.75 V to thereby measure an initial discharge capacity D1.

(Evaluation of Cycle Characteristics)

Next, the battery was charged at 2.5 mA/cm² to 4.6V, again charged at 0.25 mA/cm² to 4.6 V and then discharged at 2.5 mA/cm² to 2.75 V to thereby measure a discharge capacity Dn.

The above charge-discharge cycle was repeated to measure a 25th-cycle discharge capacity D25. A capacity retention was calculated from the following equation.

Capacity Retention (%)=(25th-cycle discharge capacity D25/Initial discharge capacity D1)×100

TABLE 1

| | | | Initial | 25th-cycle | |
|---|---|---|---|---|---|
| | | | Discharge | Discharge | Capacity |
| | | | Capacity D1 | Capacity | Retention |
| | Additive | Overdischarging | (mAh/g) | (mAh/g) | (%) |
| Present | LiB(C₂O₄)₂ | Performed | 222.0 | 168.8 | 76.7 |
| Battery | | | | | |
| Comparative | — | — | 222.1 | 157.7 | 71.0 |
| Battery 1 | | | | | |
| Comparative | LiB(C₂O₄)₂ | — | 221.8 | 155.8 | 70.2 |
| Battery 2 | | | | | |
| Comparative | — | Performed | 223.0 | 140.5 | 63.0 |
| Battery 3 | | | | | |

As can be seen from Table 1, the battery of the present invention even if charged to a high voltage, i.e., to an end voltage of 4.6 V, shows a higher capacity retention compared to the conventional comparative battery 1. Even if LiB(C₂O₄)₂ is added, unless overdischarging is performed, a capacity retention improvement after charges and discharged is not observed for a battery, as shown by the comparative battery 2. This is believed due to the absence of a film on a surface of the positive electrode, which may be formed as a result of reductive decomposition of the additive if overdischarging is performed. Without the additive, overdischarging a battery results in the reduced capacity retention, as shown by the comparative battery 3.

Although LiB(C₂O₄)₂ was used as the additive in the above Examples, the same results are also obtained where LiBF₂(C₂O₄) is used.

As described above, if an additive which is reductively decomposed in the range of +3.0-1.3 V versus metallic lithium is incorporated in a nonaqueous electrolyte of a battery and if the battery after assembled is overdischarged until a potential of its positive electrode falls down to a reductive potential of the additive or below, in accordance with the present invention, a film is formed on a surface of the positive electrode as a result of reductive decomposition of the additive, so that good cycle characteristics can be obtained even in the case where the battery is charged to a high voltage.

What is claimed is:

1. A nonaqueous electrolyte secondary battery comprising: a positive electrode containing a positive active material, a negative electrode containing a negative active material and a nonaqueous electrolyte,
wherein a lithium-containing transition metal oxide having a layered structure is contained as said positive active material, and a film containing Li, B and C is deposited on a surface of the positive electrode.

2. The nonaqueous electrolyte secondary battery as recited in claim 1, wherein a 25th-cycle capacity retention is 76.7% or more.

3. The nonaqueous electrolyte secondary battery as recited in claim 1, wherein said film is produced via reductive decomposition of at least one of LiB(C₂O₄)₂ and LiBF₂(C₂O₄).

4. The nonaqueous electrolyte secondary battery as recited in claim 1, wherein said positive active material is lithium cobaltate having Al or Mg in the form of a solid solution and Zr added to its surface.

5. The nonaqueous electrolyte secondary battery as recited in claim 2, wherein said film is produced via reductive decomposition of at least one of LiB(C₂O₄)₂ and LiBF₂(C₂O₄).

6. The nonaqueous electrolyte secondary battery as recited in claim 2, wherein said positive active material is lithium cobaltate having Al or Mg in the form of a solid solution and Zr added to its surface.

7. The nonaqueous electrolyte secondary battery as recited in claim 3, wherein said positive active material is lithium cobaltate having Al or Mg in the form of a solid solution and Zr added to its surface.
